(19) United States
(12) Patent Application Publication
(10) Pub. No.: US 2012/0170249 A1
(43) Pub. Date: Jul. 5, 2012

(54) BACKLIGHT MODULE

(75) Inventors: HSU SHAN, Kaohsiung City (TW); I-ting Huang, Kaohsiung City (TW)

(73) Assignee: CHUNGHWA PICTURE TUBES, LTD., Bade City (TW)

(21) Appl. No.: 13/083,521

(22) Filed: Apr. 8, 2011

(30) Foreign Application Priority Data
Jan. 4, 2011 (TW) 100200114

(51) Int. Cl. G02F 1/13357

(52) U.S. Cl. 362/97.1

(57) ABSTRACT

A backlight module having an elongated circuit board, a plurality of first red, green and blue (RGB) LED units, a second RGB LED unit, and a light guide plate is disclosed. The first RGB LED units are disposed on the elongated circuit board. The second RGB LED unit is disposed on at least one end of the elongated circuit board and is adjacent to the first RGB LED units. The light guide plate is disposed beside the first RGB LED units and the second RGB LED unit. The second RGB LED unit herein has a diverse displacement and/or an angular deflection with respect to the first RGB LED units, thereby preventing color deviation on both sides of a panel.

### TECHNICAL FIELD OF THE INVENTION

The present invention relates to a backlight module, and especially to a backlight module using light emitting diodes (LEDs).

### BACKGROUND OF THE INVENTION

Because a light emitting diode (LED) has advantages such as a low power consumption, long lifespan, no mercury additives and others, the LED is gradually replacing a cold cathode fluorescent lamp (CCFL) to be a mainstream backlight source. An LED backlight technology can be divided into a direct-lit type and an edge-lit type. Since the edge-lit type has an advantage of being compact in size, the edge-lit type is gradually becoming a mainstream technology. At present, a white light LED is generally utilized to serve as a light source. However, the white light LED used as the light source has shortcomings such as an uneven spectrum, color deviation, and a low color saturation because the white light LED is implemented by a blue LED chip added with yellow phosphors for color mixing. Thus, in the existing technique, an RGB LED unit, in which red, green and blue (R, G, and B) LEDs are packaged together, is provided for solving the problem of the low color saturation, thereby reaching a wider color gamut performance.

Referring to FIG. 1, FIG. 1 is a partial top view schematically showing an edge-lit backlight module using RGB LED units in the prior art. The conventional edge-lit backlight module includes a light guide plate 110, a flexible printed circuit board 120, a mold frame 140, and a plurality of RGB LED units 1301, 1302, and so on. The RGB LED units 1301, 1302, and so on are disposed on the flexible printed circuit board 120 and are located at one side of the light guide plate 110. The LEDs of three colors packaged in each one of the RGB LED units 1301, 1302, and so on are arranged in the same order, for example, the three colors red (R), green (G), blue (B) are arranged from left to right. The red (R), green (G), blue (B) lights emitted from each RGB LED unit 1301, 1302, and so on are mixed as a white light, and the white light is guided via the light guide plate 110 to serve as the backlight.

However, the red light emitted form the leftmost RGB LED unit 1301 is reflected by the mold frame 140 (usually of a white color), and there is no the other two color lights, i.e. the green (G) and blue (B) lights, to be mixed with this red light. As a result, a red color deviation occurs in the leftmost region (indicated by a dotted line) near the mold frame 140 on the light guide plate 110. Similarly, a blue color deviation will be generated on the right-most region (not shown) of the light guide plate 110. Therefore, the left and right ends of a display panel will display a more reddish color at one end and more bluish at the other end, hence reducing the viewing performance.

### SUMMARY OF THE INVENTION

Accordingly, an objective of the present invention is to provide a backlight module by changing the positions of the LEDs to solve the above-mentioned problem.

To achieve the foregoing objectives, according to the present invention, a backlight module which comprises an elongated circuit board, a plurality of first RGB LED units, a second RGB LED unit, and a light guide plate is provided. The first RGB LED units are disposed on the elongated circuit board. The second RGB LED unit is disposed on at least one end of the elongated circuit board and is adjacent to the first RGB LED units. The light guide plate is disposed beside the first RGB LED units and the second RGB LED unit. The second RGB LED unit herein has a diverse displacement and/or an angular deflection in relations to the first RGB LED units.

More specifically, the diverse displacement is a horizontal diverse displacement and/or a vertical diverse displacement. The horizontal diverse displacement is not equal to an interval between the first RGB LED units, and the horizontal diverse displacement is preferably less than a distance between the second RGB LED unit and an edge of the elongated circuit board. The vertical diverse displacement is set toward a direction away from the light guide plate. On the other hand, the angular deflection φ is less than 90 degrees minus one-half of a viewing angle of the second RGB LED unit, that is, φ<(90°-the viewing angle/2).

In one preferred embodiment, the first RGB LED units and the second RGB LED unit are side-view LEDs. The first RGB LED units and the second RGB LED unit respectively have a plurality of first light-exit surfaces and a second light-exit surface, and the light guide plate has an incident plane which is disposed parallel to the first light-exit surfaces and the second light-exit surface. The light guide plate herein has an extension portion corresponding to the second light-exit surface, which generates an equal gap between the incident plane and the first light-exit surfaces as well as the second light-exit surface. Preferably, the gap is in a range from 0 to 0.3 mm.

In accordance with the preferred embodiment of the present invention, the second RGB LED unit with respect to the first RGB LED units has a different diverse displacement and/or an angular deflection on the elongated circuit board, which makes the second RGB LED unit on the end have a larger space for mixing light; thus, the problem of the color deviation on both ends of the panel is improved.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a partial top view schematically showing an edge-lit backlight module using RGB LED units in the prior art;

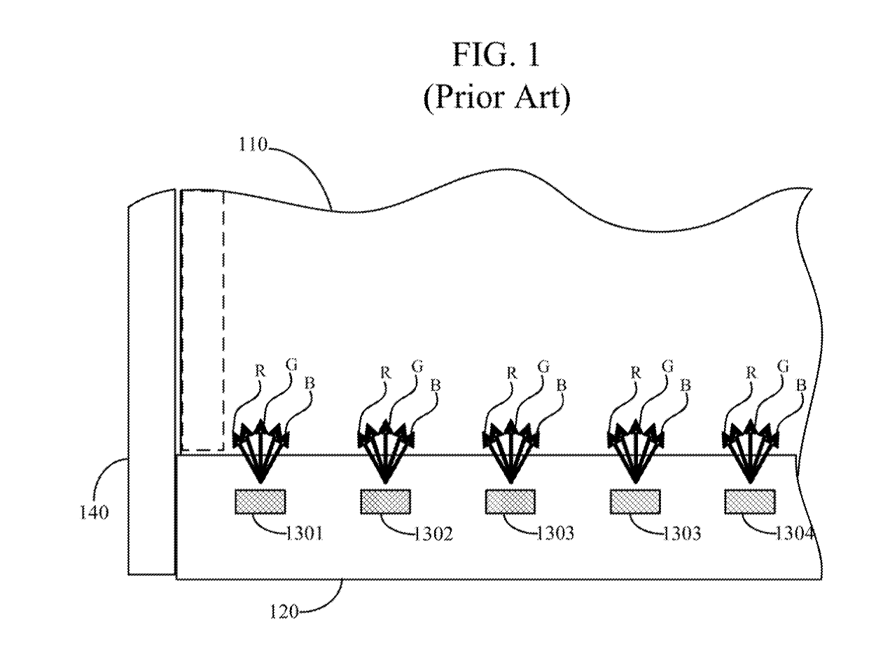

FIG. 2 is a partial top view schematically showing a backlight module according to a first preferred embodiment of the present invention;

FIG. 3 is a partial top view schematically showing a backlight module according to a second preferred embodiment of the present invention; and

FIG. 4 is a partial top view schematically showing a backlight module according to a third preferred embodiment of the present invention.

### DETAILED DESCRIPTION OF THE INVENTION

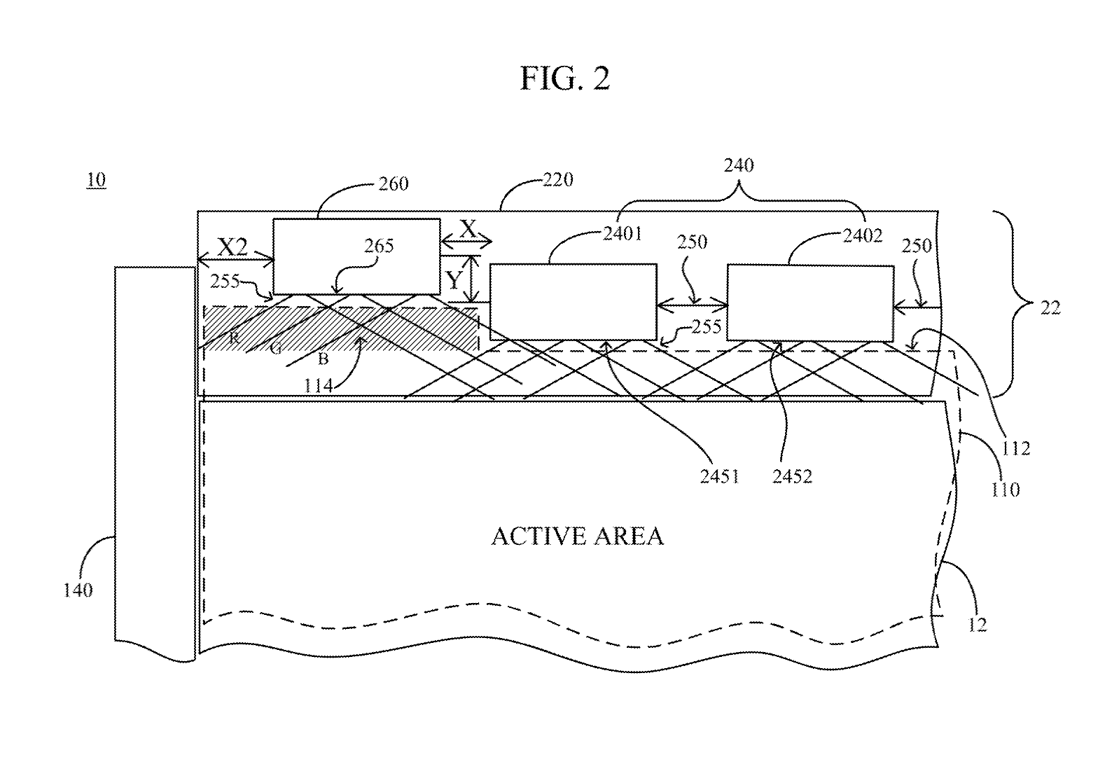

The present invention will now be described in detail with reference to a few preferred embodiments thereof as illustrated in the accompanying drawings. In different drawings, the same reference numbers will be used throughout the drawings to refer to the same or like parts. Referring to FIG. 2, FIG. 2 is a partial top view schematically showing a backlight module according to a first preferred embodiment of the present invention. The backlight module according to the first preferred embodiment of the present invention is generally designated at 10. The backlight module 10 includes an LED light bar 22, a light guide plate 110, and a mold frame 140. A transparent active area 12 is defined from the LED light bar 12 and the mold frame 140. The LED light bar 22 includes an elongated circuit board 220, a plurality of first RGB LED unit 2401, 2402, and so on and a second RGB LED unit 260.

In the preferred embodiment, the elongated circuit board 220 of the LED light bar 22 is a flexible printed circuit (FPC) board. A plurality of contacts (not shown) which are disposed on the flexible printed circuit board 220 are utilized to electrically coupled to the first RGB LED units 240 and the second RGB LED unit 260, thereby supplying the first RGB LED units 240 and the second RGB LED unit 260 with electric power for luminescence. However, the elongated circuit board 220 is not limited to the flexible printed circuit board in the present invention, and a usually printed circuit board (PCB) can also be implemented.

The first RGB LED units 240 and the second RGB LED unit 260 are disposed on the elongated circuit board 220 and connect to the contacts through well known surface mount technology (SMT). It should be noted that the first RGB LED units 240 and the second RGB LED unit 260 essentially are the same kind of LED which is a side-view LED preferably. The side-view LED herein indicates that the directions of the light exit are essentially parallel to the surface of the elongated circuit board 220. Specifically, the first RGB LED units 2401, 2402, and so on and the second RGB LED unit 260 respectively have a plurality of first light-exit surfaces 2451, 2452, and so on and a second light-exit surface 265. The red, green and blue lights are emitted via the first light-exit surfaces 2451, 2452, and so on as well as the second light-exit surface 265.

The first RGB LED units 2401, 2402, and so on are arranged on the elongated circuit board 220, and there is an identical interval 250 between the first RGB LED units 2401, 2402, and so on. In the first preferred embodiment, the second RGB LED unit 260 herein has a diverse displacement 260 with respect to the first RGB LED units 2401, 2402, and so on. Furthermore, the diverse displacement is a horizontal diverse displacement “X”, or a vertical diverse displacement “Y”, or both of the horizontal diverse displacement “X” and the vertical diverse displacement “Y” (as shown in FIG. 2). The horizontal diverse displacement “X” indicates a distance between the second RGB LED unit 260 and the first RGB LED unit 2401 adjacent to the second RGB LED unit 260.

Specifically, the horizontal diverse displacement “X” is not equal to an interval 250 between the first RGB LED units 240. Preferably, the horizontal diverse displacement “X” is less than a distance “X2” between the second RGB LED unit 260 and an edge of the elongated circuit board 220. In short, the distance “X2” between the second RGB LED unit 260 and an edge of the elongated circuit board 220 is larger than the horizontal diverse displacement “X”, so that the second RGB LED unit 260 has sufficient distance from the mold frame 140 for mixing light. Accordingly, the outermost red light of the second RGB LED unit 260 can be mixed more evenly for reducing the color deviation.

The vertical diverse displacement “Y” is defined as a vertical offset of the second RGB LED unit 260 with respect to the first RGB LED units 240. For instance, the second RGB LED unit 260 has the vertical offset relative to a direction of a connection of the first RGB LED units 2401, 2402 (such as the central horizontal axis of the first RGB LED units 2401, 2402). Furthermore, the offset direction of the vertical diverse displacement “Y” is set toward a direction away from the light guide plate 110 preferably, that is, away from the active area 12 and not exceeding the elongated circuit board 220. In accordance with the above-mentioned diverse displacements (as shown in FIG. 2), the outermost red light of the second RGB LED unit 260 can be mixed more evenly for reducing the color deviation.

Referring to FIG. 2 again, in order to explain clearly, the light guide plate 110 represents as the dashed line. A part of the light guide plate 110 is disposed on a part of the elongated circuit board 220, and there is an incident plane 112 parallel to the first light-exit surfaces 2451, 2452 and the second light-exit surface 265. There is a gap 255 between the incident plane 112 and the first light-exit surfaces 2451, 2452, and so on as well as the second light-exit surface 265, thereby avoiding the damage that the light guide plate 110 collisions the first RGB LED unit 2401,2402 and the second RGB LED unit 260. In the embodiment, the light guide plate 110 has an extension portion 114 corresponding to the second light-exit surface 256, which makes the gap 255 between the incident plane 112 and the first light-exit surfaces 2451, 2452, and so on as well as the second light-exit surface 265 equal, thereby avoiding the second light-exit surface 265 being much away from the incident plane 112 to cause optical recession. Preferably, the gap 255 is in a range from 0 to 0.3 mm.

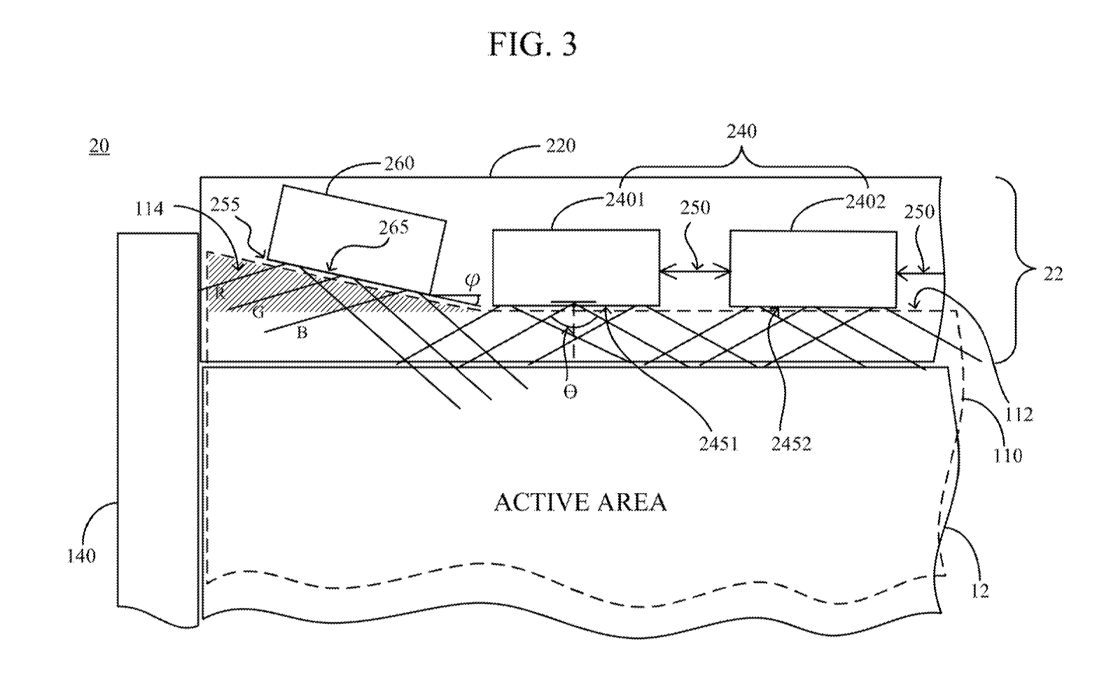

Referring to FIG. 3, FIG. 3 is a partial top view schematically showing a backlight module according to a second preferred embodiment of the present invention. The backlight module according to the second preferred embodiment of the present invention is generally designated at 20. The differences between the backlight module 20 and 10 of the second and first preferred embodiment are that the second RGB LED unit 260 has an angular deflection relative to the first RGB LED units 2401, 2402, and so on. The descriptions of other elements have been explained as above mention, so we need not go into detail herein.

The angular deflection is represented by φ, which is defined as an angle between the second light-exit surface 265 of the second RGB LED unit 260 and the first light-exit surfaces 2451, 2452, and so on. The angular deflection φ is less than 90 degrees minus one-half of a viewing angle θ of the second RGB LED unit 260, that is, φ<(90°-θ/2). For example, the first RGB LED units 240 and the second RGB LED unit 260 having a viewing angle θ that is 120 degrees, then the angular deflection φ must be less than (90°-120°/2), which is 30°. When the angular deflection φ is greater than 30°, some light will be emitted toward the direction away from the active area 12 and not being transmitted to the active area 12; thus, part of the light source of the second RGB LED unit 260 is without use. Therefore, in the preferred embodiment, the angular deflection φ is preferably 20°.

In accordance with the design of the angular deflection φ of the second RGB LED unit 260, the path of the red LED of the second RGB LED unit 260 to the mold frame 140 is the longer than the paths of other green and blue LEDs to the mold frame 140, thus the red light has a longer distance for mixing light. Furthermore, there are more green and blue lights mixed with the red light because the green and blue LEDs are also deflected toward the mold frame 140. Accordingly, the outermost red light of the second RGB LED unit 260 can be mixed more evenly for reducing the color deviation.

As mentioned above, a part of the light guide plate 110 (shown as dotted line) is disposed on a part of the elongated circuit board 220, and there is an incident plane 112 parallel disposed to the first light-exit surfaces 2451, 2452 and the second light-exit surface 265. As the previous embodiment, the light guide plate 110 also has an extension portion 114 corresponding to the second light-exit surface 256 in the embodiment, as a right-angled triangle (top view) shown in FIG. 3. The hypotenuse of the right-angle triangle is parallel to the second light-exit surface 265, so that the gap 255 between the incident plane 112 and the first light-exit surfaces 2451, 2452, and so on as well as the second light-exit surface 265 is equal, thereby avoiding the second light-exit surface 265 being much away from the incident plane 112 to cause optical recession. Preferably, the gap 255 is in a range from 0 to 0.3 mm.

In accordance with the first and second preferred embodiments, it is understandable that the second RGB LED unit 260 may also have the diverse displacement (i.e., the horizontal diverse displacement “X” and the vertical diverse displacement “Y”) and the angular deflection φ with respect to the first RGB LED units 2401, 2402, and so on. The light emitted from the second RGB LED unit 260 can be mixed with a larger area to achieve better mixing effect, thereby overcoming the problem of the color deviation on the edge of the screen.

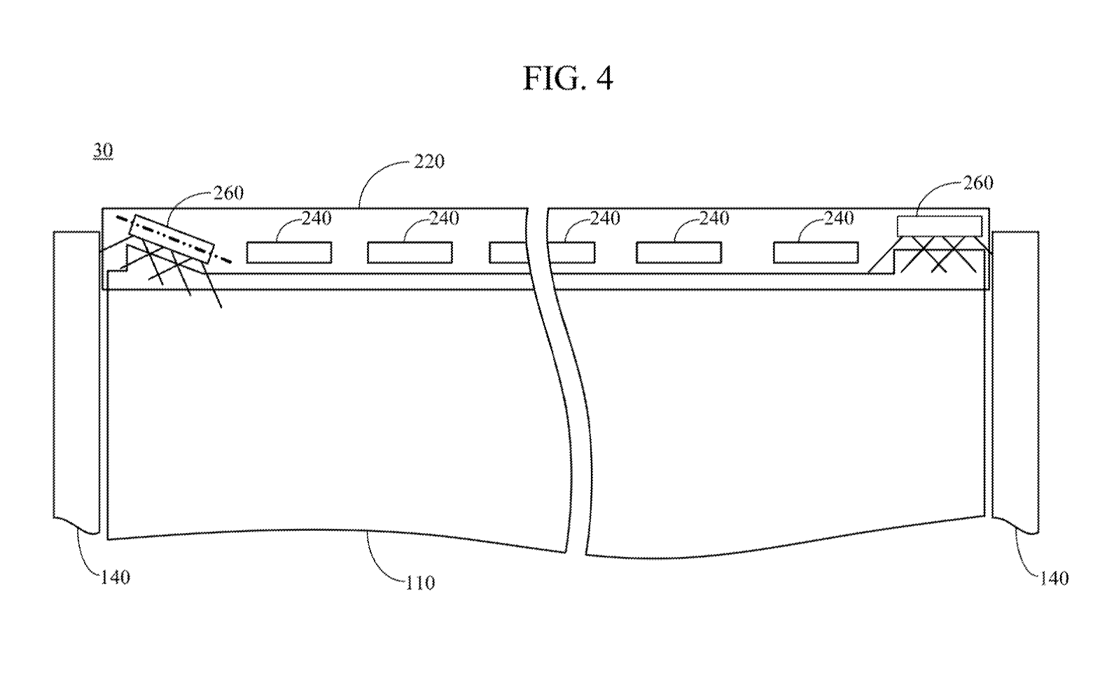

Referring to FIG. 4, FIG. 4 is a partial top view schematically showing a backlight module according to a third preferred embodiment of the present invention, in which the backlight module according to the third preferred embodiment of the present invention is generally designated at 30. The differences between the backlight module 30 and 10 or 20 of the third and first or second preferred embodiment are that there is one another second RGB LED unit 260 which is disposed on the other end of the elongated circuit board 220. The one another second RGB LED unit 260 may also have the diverse displacement (i.e., the horizontal diverse displacement “X” and the vertical diverse displacement “Y”) or the angular deflection φ, or have both of the diverse displacement and the angular deflection φ. The descriptions of other elements have been explained as above mention, so we need not go into detail herein. It is understandable that the problem that the two edges of the screen are reddish at one edge and bluish at the other edge can be solved at the same time.

While the preferred embodiments of the present invention have been illustrated and described in detail, various modifications and alterations can be made by persons skilled in this art. The embodiment of the present invention is therefore described in an illustrative but not restrictive sense. For instance, a plurality of LEDs near the mold frame 140 can be disposed with the diverse displacement and/or the angular deflection. It is intended that the present invention should not be limited to the particular forms as illustrated, and that all modifications and alterations which maintain the spirit and realm of the present invention are within the scope as defined in the appended claims.

What is claimed is:

1. A backlight module, comprising:
an elongated circuit board;
a plurality of first RGB LED units disposed on the elongated circuit board;
a second RGB LED unit, disposed on at least one end of the elongated circuit board and adjacent to the first RGB LED units; and
a light guide plate disposed beside the first RGB LED units and the second RGB LED unit;
wherein the second RGB LED unit has a diverse displacement and/or an angular deflection with respect to the first RGB LED units.

2. The backlight module of claim 1, wherein the diverse displacement comprises a horizontal diverse displacement and/or a vertical diverse displacement.

3. The backlight module of claim 2, wherein the horizontal diverse displacement is not equal to an interval between the first RGB LED units.

4. The backlight module of claim 3, wherein the horizontal diverse displacement is less than a distance between the second RGB LED unit and an edge of the elongated circuit board.

5. The backlight module of claim 2, wherein the vertical diverse displacement is set toward a direction away from the light guide plate.

6. The backlight module of claim 1, wherein the angular deflection is less than 90 degrees minus one-half of a viewing angle of the second RGB LED unit.

7. The backlight module of claim 1, wherein the first RGB LED units and the second RGB LED unit are side-view LEDs.

8. The backlight module of claim 7, wherein the first RGB LED units and the second RGB LED unit respectively have a plurality of first light-exit surfaces and a second light-exit surface, and the light guide plate has an incident plane disposed parallel to the first light-exit surfaces and the second light-exit surface.

9. The backlight module of claim 8, wherein the light guide plate has an extension portion corresponding to the second light-exit surface.

10. The backlight module of claim 7, wherein a gap between the incident plane and the first light-exit surfaces as well as the second light-exit surface is in a range from 0 to 0.3 mm.
